(19) United States
(12) Patent Application Publication
(10) Pub. No.: US 2009/0032461 A1
(43) Pub. Date: Feb. 5, 2009

(54) METHOD FOR SEPARATING POLYMER SYSTEMS AND PORE-FREE POLYMER FILMS USED IN SAID METHOD

(76) Inventors: Andreas Greiner, Amoneburg (DE); Joachim H. Wendorff, Marburg (DE); Phillip Hanefeld, Mannheim (DE); Stefan Kreiling, Heuchelheim (DE)

Correspondence Address: CLARK & BRODY, 1090 VERMONT AVENUE, NW, SUITE 250, WASHINGTON, DC, 20005, US

(21) Appl. No.: 10/539,410

(22) PCT Filed: Dec. 17, 2003
(86) PCT No.: PCT/DE2003/004161

§ 371 Date: Jan. 28, 2008

(30) Foreign Application Priority Data
Dec. 19, 2002 (DE) 102 60 036.8

(51) Int. Cl. B01D 15/34

(52) U.S. Cl. 210/635

(57) ABSTRACT

The subject matter of the invention is an innovative method for the separation of polymer systems regarding their molecular weight, chemical structure, chain architecture, and colloidal additives. Such separations are currently accomplished by selective precipitation from solution, by a fractionated crystallization also from solution, and by means of gel chromatographic methods.

The invention pertains to a separation of polymer systems by means of permeation through polymer films—semi-crystalline, cross-linked, amorphous—with thicknesses in a nanometer scale. The restriction to thicknesses in a nanometer scale is essential for a high throughput of polymers. Of particular significance is the selectivity towards colloidal additives with a structure that is not in chain form.

Polymers and the products manufactured thereof have a very significant industrial importance. This is due to, among others, characteristics such as e.g. long product life, insensitivity against many chemicals, elasticity or hardness, transparency, electric resistance, special optical characteristics and, often, their low thermal conductivity. Polymers, in the sense of the present invention, are synthetic polycondensates, addition polymers or polymerizates, but also natural long-chain compounds. The chain architecture (linear, branched, block-like structure of different elements) and the stereo chemistry (atactic, syndiotactic, isotactic) of the yielding polymer as well as the molecular weight (chain length) can indeed be controlled by appropriate selection of the process parameters; however, as with all syntheses in organic chemistry, the formation of byproducts, the formation of chains of various lengths as well as chains with objectionable stereo chemistry are unavoidable. In many cases, this has negative effects on the characteristics and applications. A separation of the reaction mixture is therefore, in many cases, necessary.

There are numerous methods for the separation of macromolecules from their mixture of low-/high-molecular substances in the current technical state of the art. These include selective precipitation from a solution, fractionated crystallization, likewise from solution, as well as gel chromatographic methods. Within a range of methods, the separation effect is based on a size exclusion (J. Porath, P. Flodin, Nature 183, 1657 (1959); J. C. Moore, J. Polym. Sci, A2, 835 (1954); W. W. Yau, J. J. Kirkland, D. D. Bly, Modern Size Exclusion Liquid Chromatography: Practice of Gel Permeation and Gel Filtration Chromatography, Wiley, N.Y. (1979); J. V. Dankins, in Comprehensive Polymer Science, Vol. I, p. 231, G. Allen, J. Bevington eds, Pergamon Press, Oxford (1989)).

During gel filtration chromatography (GFC) or gel permeation chromatography (GPC), a solution containing the polymers is sent through a column filled with gel particles containing various sized pores. The separation takes place through the accessibility of the gels' pores as a function of the particle size and, therefore, also the molecular weight. The decisive value is the hydrodynamic volume Vₕ. If the latter is equal for different polymers or particles respectively (e.g. polystyrene and polymethylmethacrylate or also coils and/or compact spheres), no separation takes place. The aforementioned methods serve especially to characterize according to size or hydrodynamic volume. A separation of substances is limited to very small quantities which are typically measured in a scale smaller than grams. The separation by means of gel-chromatography is strongly limited concerning the throughput quantity. DE 3831970 A1 and DE 3934068 A1 describe particles to be used within the gel permeation chromatography. These particles allow for the separation of polymeric substances according to their size or their hydrodynamic volume, whereby the throughput is limited to the scale of grams.

A further type of separation method is characterized by exposure to a field which might be electrical, thermal or an electromagnetic flux, in a perpendicular direction to the solvent flow containing the substances to be separated (J. C. Giddings, K. A. Graff, K. D. Caldwell, M. N. Myers in Advances in Chromatography, p. 203; C. D. Craver ed., Dekker N.Y. 1983; J. J. Gunderson, J. C. Giddings, in Comprehensive Polymer Science, Vol. I, p. 279, G. Allen, J. Bevington eds, Pergamon Press, Oxford (1989)). These fields cause a spatial separation of different substances according to the coupling to the field, resulting in allocation to different layers of laminar flows. Compared with GFC and GPC, these methods have the advantage that they not only discriminate in regard to the hydrodynamic volume, but also, e.g., according to electrical parameters caused by a specific chemical structure. Among the disadvantages of this method are its limitation to low concentrations in order to avoid overloading, the limitation regarding the effectively separable quantity as well as the fact that wide distributions at the respective heading and tailing are not dissolved. The quantity limitation does not apply as strictly to a fractionation of varying solubilities in predetermined solvents (R. Koningsveld, L. A. Kleinjens, H. Geerissen, P. Schützeichel, B. A. Wolf, Comprehensive Polymer Science, Vol. I, p. 293; G. Allen, J. Bevington eds, Pergamon Press, Oxford (1989); B. A. Wolf, Adv. Polym. Sci. 10, 109 (1972)). Further methods, such as thin layer chromatography (TLC), play a marginal role in a characterization of the molecular weight distribution and play no role at all concerning a quantitative separation (H. Inagaki, Adv. Polym. Sci 24, 189 (1977)).

To date, with the help of gel-chromatographic and electrophoretic methods, biopolymers such as DNA and RNA fragments with masses up to 20-40 kB (agarose gel) or 1000 kB (pulse gel electrophoresis) respectively, can be separated (J. Sambrook, E. F. Fritsch, T. Maniatis: Molecular cloning: A Laboratory Manual, 2nd Edition (1989)).

Separations of biopolymers, as for example nucleic acids, with the help of spherical magnetic silica particles with adjustable particle size and adjustable magnetic content are described in DE 10035953 A1. DE 69026090 T2 describes the fractionation in counter migration with the help of capillary electrophoresis, and DE 69221969 T2 describes polymer solutions for capillary electrophoresis, with the help of which biological molecules with molecule masses up to a few kDa can be separated. Both methods serve to separate proteins and nucleic acids. The separation of proteins with magnetic silica gel particles is limited to the milligram scale, the capillary electrophoresis to the picogram scale.

DE 3851616 T2 describes macroporous polymer membranes with thicknesses in the millimeter scale which possess a globular (spherical) microstructure with communing free spaces in between. In this method, the membranes serve as adsorbents for the components of the mixture to be separated. Subsequently, these components are successively eluted, with the help of suitable eluents. With the help of these polymer membranes, synthetic polymers and biopolymers can be separated in the gram scale.

However, until now, it has proved very difficult to separate mixtures of macromolecular and, in particular, polymer systems in quantities above the gram scale. Thus, DE 4214527 C2 describes a method for the processing of packaging materials which contain one or more polymers, by dissolving the polymer portions in organic solvents and subsequently thermally processing them into products with monomer character. This method allows for the application of polymer mixtures in the kilogram scale and delivers pure grade separated products; however, the polymer character is lost during the purification process.

While separating non-polymer substance mixtures and the purification of substances in the gaseous phase and in the liquid phase, with the help of polymers and polymer systems, one frequently utilizes the adsorption and permeation characteristics of polymers. On the one hand, many polymers are able to adsorb substances which afterwards can be selectively re-dissolved; on the other hand, many polymers are permeable for other, gaseous substances. Thus, they can be penetrated by them.

DE 69505583 T2 describes polymer membranes, with the help of which organic solvents can be separated from aqueous solvents. A greater throughput quantity of the mixture to be separated is thereby possible; however, only organic molecules with molecule masses of up to approx. 200 g/mol can be separated. Similar facts apply for the separation of acidic gasses from gaseous mixtures which is described in DE 19600954 C2, and for the membrane for the separation of substance mixtures described in DE 19836418 A1: Both allow for a high substance throughput, but, however, are permeable only for molecules with molecule masses up to a maximum of approx. 1000 g/mol.

The permeation behavior of small molecules through polymer films has been very thoroughly examined, namely for gasses as well as liquids (J. Crank, G. S. Park, “Diffusion in Polymers”, Academic Press, N.Y., 1968; J. Comyn Ed., Polymer Permeability, Elsevier Appl. Sci. London, 1986; H. B. Hopfenberg, V. Stannett in “The Physics of Glassy Polymers”, R. N. Haeward Ed. Applied Science Publ. London, 1973, p. 504; T. V. Naylor in “Comprehensive Polymer Science”, S. G. Allen Ed., Pergamon Press, N.Y., 1989; F. Bueche, “Physical Properties of Polymers”, Interscience Publ. N.Y. (1962); H. G. Elias, “Makromoleküle”, Hüthig und Wepf, Basel (1975)).

None of the aforementioned methods, however, allows for the separation of macromolecules with high selectivity and high throughput quantity.

Surprisingly, and in contradiction with the technical state of the art hitherto, it was established that long chain molecules can diffuse not only through polymer films, so that a separation of macromolecules by polymer films is possible. The separation effect of the polymer film, therefore, depends on the permeation of the substances to be separated and, hence, the reptation in combination with the solubility of the permeants in the polymer film.

The object of the current invention is to provide a method that allows for the separation of macromolecules from their mixtures of low and high molecular substances with high selectivity and/or high throughput quantity for the first time.

According to the present invention, this object is achieved by a method according to claim 1 using at least one non-porous polymer film, whereby the temperature of this at least one non-porous polymer film is equal to or greater than the glass transition temperature T_{G} of this at least one non-porous polymer film, and whereby under non-porous, those films are meant which have pores that do not completely impenetrate from one side to the other. The polymer films defined as “non-porous” according to the above definition can also be considered as closed polymer films.

A further object of the invention is to provide a suitable separation medium for the separation of macromolecules from their mixture of low-/high-molecular substances, whereby this separation medium allows for the separation of macromolecules from their mixture of low-/high-molecular substances with high selectivity and/or high throughput quantity. According to the present invention, this object is achieved through use of separation media containing at least one non-porous polymer film according to claim 26, whereby under non-porous, those films are meant which have pores that do not completely impenetrate from one side to the other.

Surprisingly, and in contradiction to currently existing publications, it was found that it is possible to separate polymer systems, effectively and in large quantities, by means of the permeation of polymer systems through a non-porous polymer film.

These polymer films allow macromolecules to permeate from one side of the film, around the chain molecules in the film, to the other side of the film. During this permeation process, macromolecules diffuse around the long chain molecules of which the polymers consist. This permeation process is also referred to as reptation, wherein one understands reptation as being the curvilinear movement along a chain, around the hindrances. During this, a separation process with respect to molecular weight, chain architecture and particle shape arises. Hence, the non-porous polymer films are suitable for separating macromolecules from their mixtures with low and high molecular substances.

The requirement for permeation or reptation is an adequate mobility of the molecules of which the polymer film consists or which the polymer film contains. It is known to the person skilled in the art that all polymers—also those that are crystalline as well as semi-crystalline—contain amorphous regions.

In combination with the present invention, within the framework of the research which led to the current invention, it was found that the amorphous regions of non-porous polymer films are sufficiently mobile after reaching the glass transition temperature T_{G} to allow macromolecules to permeate through this film.

Within the framework which led to the current invention, it was found that no swelling of the polymer film with a liquid medium is necessary before permeation if the glass transition temperature T_{G} of the non-porous polymer film employed as the separating agent is under the temperature at which the separation of macromolecules is conducted (separation temperature). Furthermore, it was found during the research connected to the current invention that glass transition temperatures T_{G} of amorphous regions above the separation temperature can be lowered to T_{G}-values beneath the separation temperature through swelling with a liquid medium in order to allow for the permeation of macromolecules through the polymer film.

The method according to the present invention, for the separation of macromolecules from their mixtures with low and high molecular substances, separates these systems through film permeation (FP) in regard to molecular weight and/or chemical structure of the chain molecules and/or chemical structure of the chain molecules in mixtures and/or the degree of branching and/or the chain architecture, and/or it is suitable for the separation of flexible ball-shaped macromolecules from stiff-chain rod-shaped macromolecules and/or for the separation of linear and cyclic macromolecules and/or for the separation of chemical impurities in synthetic materials (monomers, oligomers, byproducts of the synthesis) and/or for the separation of catalysts, colloidal additives and other additives, wherein a high throughput quantity of the mixture to be separated is achieved in short timeframes.

Great amounts of macromolecules can be separated from their mixtures with low- and high-molecular substances.

The polymer films that can be utilized in the separation method according to the present invention are produced via methods known to the person skilled in the art by means of chemical vapor deposition (CVD), plasma polymerization, spin-coating, sublimation, doctor blading, spraying, or extrusion.

The films utilized as separation media are crystalline, semi-crystalline, or amorphous, chemically cross-linked or non-cross-linked; they can be copolymers, block copolymers, or polymer alloys; they can consist of several films or several polymers of different chemical structures that exist as multi-layer films or tandem systems, feature a chemical gradient in which the chemical composition changes systematically throughout the film, consist of reactive polymers that are capable of chemical reactions such as cross-linking and/or binding specific groups, feature a special surface topology (rough and/or porous surface, wherein the pores do not permeate the film completely from side to side), contain solid flux (carbon black, mica, chalk, etc.), be coated on or between porous substrates (inorganic or organic porous membranes or tissue), and/or exist in the form of hollow fibers. Where films consisting of hollow fibers are utilized as separation media, the permeation of the mixture to be separated takes place through the walls of the hollow fibers. Multi-layer films as separation medium are films that consist of at least two layers of identical or different polymers, with no space between two layers in each case. Tandem configurations are systems in which several permeation configurations are arranged one after the other or parallel with liquid media between the polymer films utilized as separation media and arranged one after the other and/or parallel.

Suitable polymer films consist of and/or contain polymers such as poly-(p-xylylene), polyvinylidene halides, polyester, polyether, polyolefins, polycarbonates, polyurethanes, natural polymers, polycarboxylic acids, polysulfonic acids, sulphated polysaccharides, polylactides, polyglycosides, polyamides, polyvinylalcohols, poly-α-methylstyrenes, polymethacrylates, polyacrylnitriles, poly-(p-xylyles), polyacrylamides, polyimides, polyphenylenes, polysilanes, polysiloxanes, polybenzimidazoles, polybenzthiazolenes, polyoxazoles, polysulfinides, polyesteramides, polyarylenvinylenes, polyetherketones, polyurethanes, polysulfones, ormocerenes, polyacrylates, silicones, fully aromatic copolyesters, poly-N-vinylpyrrolidones, polyhydroxyethylmethacrylates, polymethylmethacrylates, polyethylenterephthalates, polymethacrylnitriles, polyvinylacetates, neoprene, Buna N, polybutadienes, polytetrafluorethylenes, modified or unmodified celluloses, α-olefins, vinylsulfonic acids, maleic acids, alginates or collagens.

The monomers that form the basis of the polymers can each support one or more functional groups, while, in each case, they can be of one or different types of substituents. This relates to the following functional groups:

H, linear or branched alkyl, alkenyl, alkinyl, cycloalkyl, cycloalkenyl, cycloalkinyl, phenyl, phenylalkyl, phenylalkenyl, phenylalkinyl, phenylcycloalkyl, phenylcycloalkenyl, phenylcycloalkinyl, cycloalkyl-alkyl, cycloalkyl-alkenyl, cycloalkyl-alkinyl, heterocyclic compounds, heterocyclo-alkyl, heterocyclo-alkenyl, heterocyclo-alkinyl, linear or branched alkylsulphonate, alkenylsulphonate, alkinylsulphonate, linear or branched alkylbenzenesulphonate, alkenylbenzenesulphonate, alkinylbenzenesulphonate, aminosulphonyl-alkyl, aminosulphonyl-alkenyl, aminosulphonyl-alkinyl, aminosulphonyl-cycloalkyl, aminosulphonyl-cycloalkenyl, aminosulphonyl-cycloalkinyl, linear or branched alkyl-sulphonamide, alkenyl-sulphonamide, alkinyl-sulphonamide, cycloalkyl-sulphonamide, cycloalkenyl-sulphonamide, cycloalkinyl-sulphonamide, phenyl-sulphonamide, heterocyclo-sulphonic acid, heterocyclo-sulphonamide, heterocyclo-alkyl-sulphonic acid, heterocyclo-alkyl-sulphonamide, heterocyclo-alkenyl-sulphonic acid, amide- or ester-like bound linear and/or branched-chain aliphatic sulphonic, carboxylic and/or phosphonic acid, styrene sulphonic acid, anetol sulphonic acid, styrene phosphonic acid, heterocyclo-alkenyl-sulphonamide, heterocyclo-alkinyl-sulphonic acid, heterocyclo-alkinyl-sulphonamide, aryl-sulphonic acid, aryl-sulphonamide, aryl-alkyl-sulphonic acid, aryl-alkyl-sulphonamide, aryl-alkenyl-sulphonic acid, aryl-alkenyl-sulphonamide, aryl-alkinyl-sulphonic acid, aryl-alkinyl-sulphonamide, alkyl-, alkenyl, alkinyl-, aryl-, heteroalkyl-, heteroaryl-carboxylic acids, esters thereof, carboxylic acid amides thereof, amino acids, orthologous phosphonic acid derivatives of all sulphonic acids listed, hydroxy-alkyl-, hydroxy-alkenyl-, hydroxy-alkinyl-, hydroxy-cycloalkyl-, hydroxy-alkyl-cycloalkyl-, hydroxy-cycloalkyl-alkyl-, hydroxy-phenyl-, hydroxy-alkyl-phenyl-, hydroxy-phenyl-alkyl-groups as well as the orthologous amino- and thio-compounds, polyethoxy-alkyl, polyethoxy-alkenyl, polyethoxy-alkinyl, polyethoxy-cycloalkyl, polyethoxy-cycloalkenyl, polyethoxy-cycloalkinyl, polyethoxy-aryl, polyethoxy-alkyl-aryl, polyethoxy-heterocycloalkyl, polyethoxy-heterocycloaryl, alkanal, alkenal, alkinal, cycloalkenal, benzene carbaldehyde, heteroaryl-carbaldehyde, benzyl-alkyl-carbaldehyde, heteroaryl-carbaldehyde, aliphatic heteroalkyl-alkenal, hetero-alkenyl-alkenal, hetero-alkinyl-alkenal, alkanon, alkenon, alkinon, cycloalkyl-alkanon, dicycloalkanon, arylalkanon, heteroaryl-alkanon, imines, halogens and halogenated derivatives of all groups listed, nitriles, isonitriles, sulphonic acid esters, phosphonic acid esters, nitro compounds, hydroxylamines, allyl compounds, adenosine-3′,5′-monophosphate, adenosine-3′,5′-diphosphate, adenosine-3′,5′-triphosphate, guanosine-3′,5′-monophosphate, guanosine-3′,5′-diphophate, guanosine-3′,5′-triphosphate, dextran sulphate cellulose, cation exchanging groups, anion exchanging groups. Preferably, therein,
alkyl stands for a group with 1-20 carbon atoms
alkenyl und alkinyl stand for a mono- or polyunsaturated group with 3-20 carbon atoms
the heterocyclic groups stand for an R group with 1-20 carbon atoms, wherein up to 5 carbon atoms can be replaced by hetero atoms which are selected from the group nitrogen, oxygen, sulfur, phosphorus
aryl stands for an aromatic R group with 5-20 carbon atoms
heteroaryl stands for a corresponding aromatic R group in which up to 5 carbon atoms can be replaced by hetero atoms from the group nitrogen, oxygen, sulfur, phosphorus.

Subsequently, the polymer films—e.g. equipped with gaskets if necessary—are typically built into a two-chamber or multiple-chamber configuration. The chambers are filled with a solvent on the one side (analysis chamber), and with a solution of the same or some other solvent containing the permeants on the other side (sample chamber) or, when the permeants are liquid, they can be brought into the sample chamber without an additional solvent. In the case of the utilization of tandem systems, several permeation configurations are aligned parallel and/or one after the other, wherein, between the polymer films that are utilized as separation media and aligned one after the other and/or parallel, there are liquid media in the form of solvents or mixtures of solvents.

The solvent or mixture of solvents can consist of protic, aprotic, aqueous, aliphatic, aromatic, heteroaliphatic, heteroaromatic, alicyclic and/or heteroalicyclic liquids.

Subsequently, the permeation of the permeation mixture's components takes place, wherein permeation velocity depends on the physicochemical properties of each component and thereby allows for a separation of the mixture. In the analysis chamber, which is initially free from polymer components, the pure singular components of the mixture can be extracted selectively according to their chronological arrival.

The separation method can be carried out continuously or discontinuously by means of the method known to a person skilled in the art in combination with light dispersion, viscosimetry, UV-Vis spectroscopy, gel permeation chromatography (GPC) or solvent precipitation or at a pressure adjusted in a controlled manner.

### PRACTICAL EMBODIMENT 1

### Films Suitable for Polymerpermeation

### REFERENCE EXAMPLE 1

### Poly-(P-Xylylene) Films (PPX)

PPX films were produced via the CVD technique (chemical vapor deposition) known to the person skilled in the art in the thicknesses desired ranging from 500 nm to 5 μm. This technique ensures the production of non-porous films.

### REFERENCE EXAMPLE 2

### Polyvinylidene Fluoride Films (PVDF)

PVDF films were produced from solution at increased temperatures (ranging from 40 to 80° C.) via the spin-coating technique known to the person skilled in the art. Films with thicknesses of between 500 nm and 3.6 μm were produced.

### REFERENCE EXAMPLE 3

### Polyethylene Films (PE)

Technical PE films with thicknesses in the range of 100 μm were employed.

### PRACTICAL EMBODIMENT 2

### Permeation Configuration

### REFERENCE EXAMPLE 4

### Configuration for Experiments on a Laboratory Scale

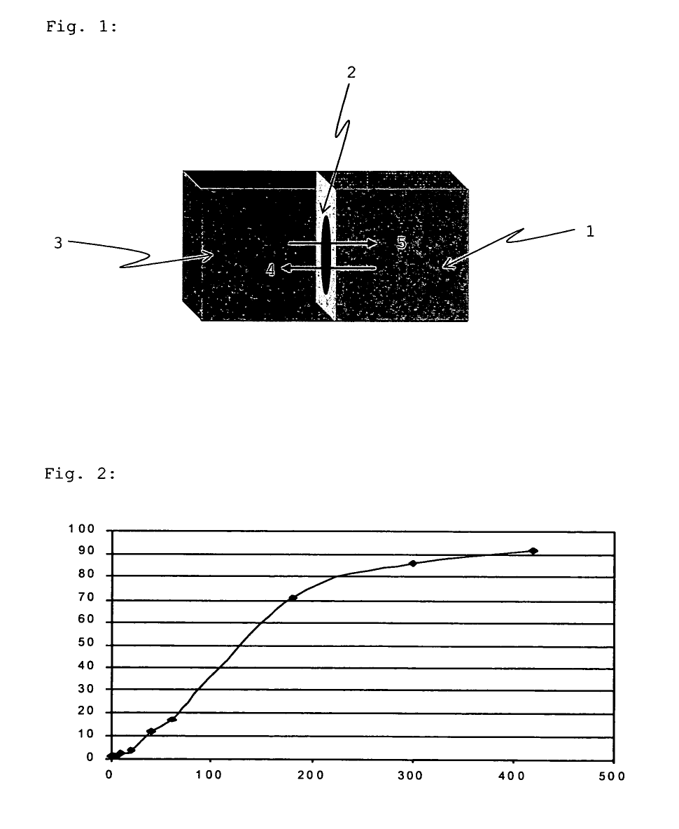

The films—equipped with gaskets—were inserted into a two-chamber configuration, wherein the surface area of the films was in the range of few cm² (cf. FIG. 1). The chambers were filled with a solvent on the analysis side and with a solution containing the respective mixture of permeants on the sample side. The volume of the sample amounted to approx. 40 ml, and the polymer concentration was in a range of 1-10%.

### PRACTICAL EMBODIMENT 3

### Permeations

### REFERENCE EXAMPLE 5

### Permeation of Chloroform Through a PPX Film

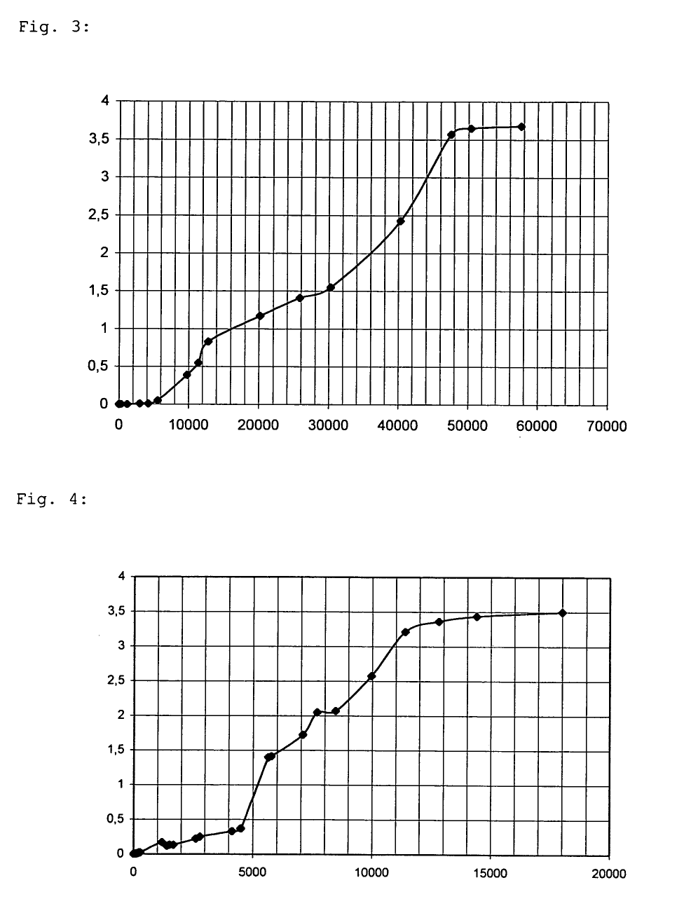

A PPX film with a thickness of 3.6 μm and a diameter of 2 cm was utilized. Approx. 40 ml of deuterated chloroform was filled into the analysis chamber of the permeation apparatus; the sample chamber was filled with the same volume of non-deuterated chloroform. As a standard reference, a defined amount of methanol was utilized. The permeation of non-deuterated chloroform into the analysis chamber was determined by means of a ¹H-NMR measurement. What was recognizable was an initial phase caused by a swelling of the PPX film, followed by a permeation phase (cf. FIG. 2).

### REFERENCE EXAMPLE 6

### Permeation of Acetone Through a PPX Film

A PPX film with a thickness of 3.6 μm and a diameter of 2 cm was utilized. Approx. 40 ml of deuterated acetone was filled into the analysis chamber of the permeation apparatus; the sample chamber was filled with the same volume of non-deuterated acetone. As a standard reference, a defined amount of methanol was utilized. The permeation of non-deuterated acetone into the analysis chamber was determined by means of a ¹H-NMR measurement. Within a 36-hour time period after the beginning of the test series, no increase in the concentration of acetone could be found in the chamber with deuterated acetone. Permeation did not occur, the test series was cancelled. The result is consistent to theory since acetone should not swell PPX.

### REFERENCE EXAMPLE 7

### Permeation of Polyethylene Oxide Through a PPX Film

A PPX film with a thickness of 3.6 μm and a diameter of 2 cm was utilized. The sample chamber was filled with a solution of polyethylene oxide (hydroxy end groups, molecular weight 200 g/mol=PEO 200) in deuterated chloroform, the analysis chamber was filled with the same solvent volume of pure deuterated chloroform. By taking samples from the analysis chamber and a subsequent ¹H-NMR spectroscopy, the permeation of PEO 200 was determined. It was clearly discernible that PEO 200 cannot be detected inside the analysis chamber until after approx. 160 hours. After approx. 400 hours, approx. 0.5 g of PEO 200 had permeated through the PPX membrane (cf. FIG. 3).

### REFERENCE EXAMPLE 8

### Permeation of Polyethylene Oxide Through a PPX Film

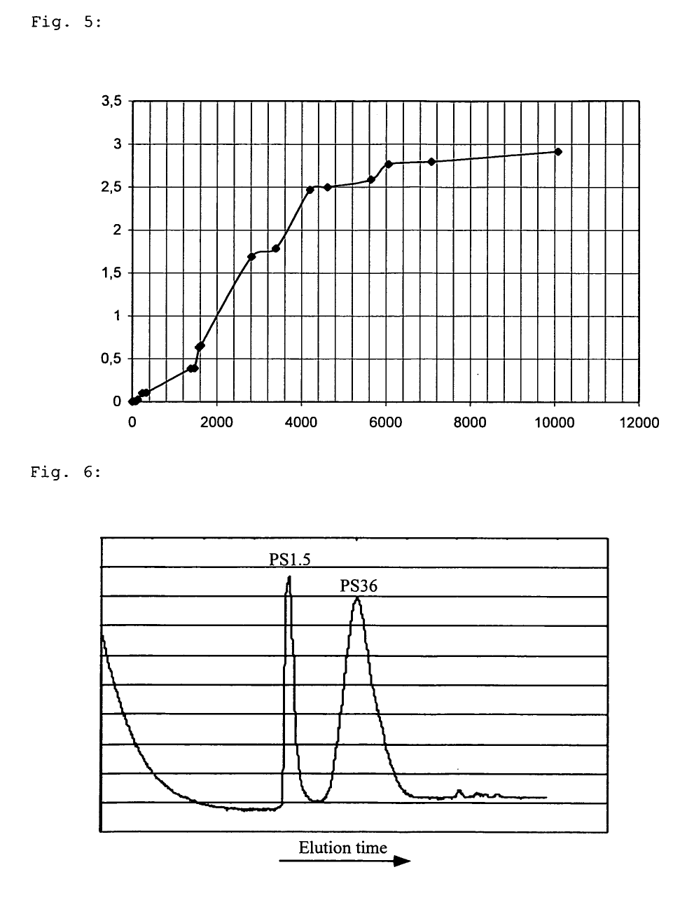

A PPX film with a thickness of 2.4 μm and a diameter of 2 cm was utilized. The sample chamber was filled with a solution of polyethylene oxide (hydroxy end groups, molecular weight 200 g/mol=PEO 200) in deuterated chloroform; the analysis chamber was filled with the same solvent volume of pure deuterated chloroform. By taking samples from the analysis chamber and subsequent ¹H-NMR spectroscopy, the permeation of PEO 200 was determined. It was clearly discernible that PEO 200 can already be detected inside the analysis chamber after a few minutes. After approx. 400 hours, approx. 2.5 g of PEO 200 had permeated through the PPX membrane (cf. FIG. 4).

### REFERENCE EXAMPLE 9

### Permeation of Polyethylene Oxide Through a PPX Film

A PPX film with a thickness of 1.3 μm and a diameter of 2 cm was utilized. The sample chamber was filled with a solution of polyethylene oxide (hydroxy end groups, molecular weight 200 g/mol=PEO 200) in deuterated chloroform, the analysis chamber was filled with the same solvent volume of pure deuterated chloroform. By taking samples from the analysis chamber and a subsequent ¹H-NMR spectroscopy, the permeation of PEO 200 was determined. It was clearly discernible that PEO 200 can already be detected inside the analysis chamber after a few minutes. After approx. 400 hours, approx. 2.9 g of PEO 200 had permeated through the PPX membrane (cf. FIG. 5).

### REFERENCE EXAMPLE 10

### Permeation of a Polystyrene Mixture Through a PPX Film

A PPX film with a thickness of 1.3 μm and a diameter of 2 cm was utilized. The sample chamber was filled with a mixture of polystyrene (molecular weight 3,600 g/mol=PS36) and polystyrene (molecular weight 1,500,000 g/mol=PS1.5), dissolved in chloroform.

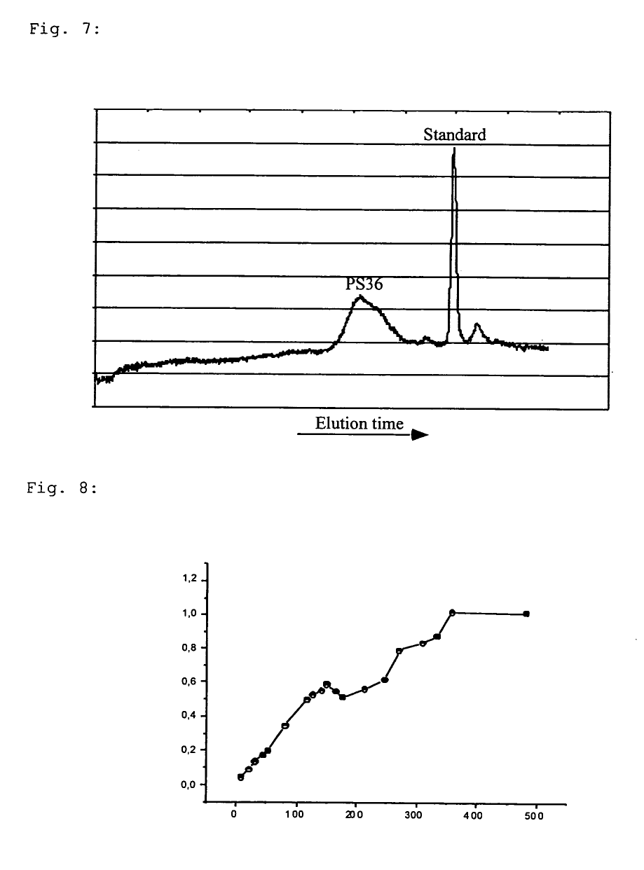

The extracted samples were examined by means of a gel permeation chromatography (GPC). Gel permeation chromatographies of the initial mixture (cf. FIG. 6) and of the permeate extracted after 24 hours (cf. FIG. 7) showed that the polymers could distinctly be separated by means of the GPC. The sample taken after 24 hours distinctly showed that only PS36 had permeated through the PPX membrane, whereas the more highly molecular PS1.5 had not reached the analysis chamber.

### REFERENCE EXAMPLE 11

### Permeation of Decane Through an LDPE Film

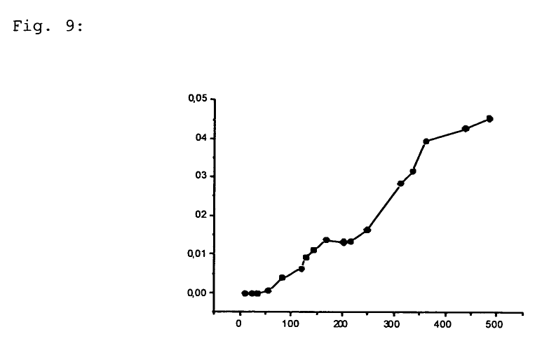

A film made of low density polyethylene (LDPE), with a thickness of 100 μm and a diameter of 2 cm, was utilized. 85 g of CDCl₃ and 2.99 g of decane (C₁₀) were brought into the sample chamber. The analysis chamber was filled with 80 g of pure CDCl₃. After approx. 350 hours, approx. 11.0 g of decane had permeated (cf. FIG. 8). The decane that had permeated into the analysis chamber was verified by means of a ¹H-NMR spectroscopy.

### REFERENCE EXAMPLE 12

### Permeation of Squalane Through an LDPE Film

A film made of LDPE, with a thickness of 100 μm and a diameter of 2 cm, was utilized. 2.97 g of squalane (C₃₀) were dissolved in 80 g of chloroform and inserted into the sample chamber. The squalane which had permeated into the analysis chamber was verified by means of a ¹H-NMR spectroscopy. Within approx. 350 hours, approx. 0.04 g of squalane permeated through the LDPE membrane (cf. FIG. 9).

### REFERENCE NUMERAL LIST

FIG. 1:

1. Sample chamber with the dissolved mixture of permeants

2. Polymer film and/or polymer membrane

3. Analysis chamber with a (pure) solvent and/or a (pure) mixture of solvents

4. Permeation of the permeant/s through the polymer film and/or the polymer membrane

5. Permeation of the solvent/mixture of solvents through the polymer film and/or the polymer membrane

FIG. 2: Permeation of chloroform through a PPX film

Permeation of chloroform through a PPX film with a thickness of 3.6 μm at a diameter of 2 cm. In the sample chamber, approx. 40 ml of non-deuterated chloroform were provided, in the analysis chamber, approx. 40 ml of deuterated chloroform were Provided. The concentration distribution of the non-deuterated chloroform's permeation was determined by means of a ¹H-NMR measurement. A defined amount of methanol served as a standard reference.

X axis: time measured in minutes

Y axis: portion of the non-deuterated chloroform in the analysis chamber containing only deuterated chloroform initially (V/V)

FIG. 3: Permeation of PEO 200 through a PPX film with a thickness of 3.6 μm

Permeation of PEO 200 through a PPX film with a thickness of 3.6 μm and a diameter of 2 cm. The sample chamber was filled with a solution of approx. 40 ml of polyethylene oxide in deuterated chloroform; the analysis chamber was filled with approx. 40 ml of deuterated chloroform. The permeation of PEO 200 into the analysis chamber was determined by means of a ¹H-NMR measurement.

X axis: time measured in hours

Y axis: amount of the PEO 200 permeated through the PPX membrane in g

FIG. 4: Permeation of PEO 200 through a PPX-Film with a thickness of 2.4 μm

Permeation of PEO 200 through a PPX film with a thickness of 2.4 μm and a diameter of 2 cm. The sample chamber was filled with a solution of approx. 40 ml of polyethylene oxide in deuterated chloroform, the analysis chamber was filled with approx. 40 ml of deuterated chloroform. The permeation of PEO 200 into the analysis chamber was determined by means of a ¹H-NMR measurement.

X axis: time measured in hours

Y axis: amount of PEO 200 permeated through the PPX membrane

FIG. 5: Permeation of PEO 200 through a PPX film with a thickness of 1.3 μm

Permeation of PEO 200 through a PPX film with a thickness of 1.3 μm and a diameter of 2 cm. The sample chamber was filled with a solution of approx. 40 ml of polyethylene oxide in deuterated chloroform, the analysis chamber was filled with approx. 40 ml of deuterated chloroform. The permeation of PEO 200 into the analysis chamber was determined by means of a ¹H-NMR measurement.

X axis: time in hours

Y axis: amount of PEO 200 permeated through the PPX membrane in g

FIG. 6: Gel permeation chromatography of a mixture of PS 36 und PS1.5 in chloroform

Gel permeation chromatogram of a mixture of PS 36 and PS1.5 (initial concentration: 0.05 g/l, maximal elution time=110 minutes). The figure shows the separation of the two components of the polymer mixture.

X axis: elution time (min)

Y axis: detector signal (mV)

FIG. 7: Selective Permeation of PS 36 through a PPX film, determined by means of GPC measurements

Permeation of a mixture of PS 36 and PS1.5 through a PPX film with a thickness of 1.3 μm and a diameter of 2 cm. The sample chamber was filled with approx. 40 ml of a mixture of the two polymers in deuterated chloroform; the analysis chamber was filled with approx. 40 ml of deuterated chloroform. The samples extracted from the analysis chamber were examined by means of a GPC after 24 hours. At this point in time, PS 36 was found exclusively in the permeate.

X axis: elution time

Y axis: detector signal (mV)

FIG. 8: Permeation of decane through an LDPE film

Permeation of decane through an LDPE film with a thickness of 100 μm and a diameter of 2 cm. 85 g of chloroform and 2.99 g of decane were inserted into the sample chamber. The analysis chamber was filled with 80 g of pure chloroform. The decane that had permeated into the analysis chamber was determined by means of a ¹H-NMR measurement.

X axis: time in hours

Y axis: amount of the decane permeated altogether in g

FIG. 9: Permeation of squalane through an LDPE film Permeation of squalane through an LDPE film with a thickness of 100 μm and a diameter of 2 cm. 2.97 g of squalane in 80 g of chloroform was inserted into the sample chamber. The analysis chamber was filled with 80 g of pure chloroform. The squalane that had permeated into the analysis chamber was determined by means of a ¹H-NMR measurement.

X axis: time in hours

Y axis: amount of the squalane permeated altogether in g

1. A method for the separation of macromolecules from their mixtures of high and low molecular substances characterized in that
at least one non-porous polymer film is utilized as a separation medium by exploiting the permeation of the film
films are considered non-porous if their pores do not completely impenetrate the film from side to side
during separation, the temperature of the at least one nonporous polymer film is equal to or greater than the glass transition temperature of the amorphous regions of said at least one polymer film used for the separation.

2. A method according to claim 1, characterized in that, in the case that the temperature of the at least one non-porous polymer film utilized as a separation medium is lower than the glass transition temperature of the amorphous regions of this at least one non-porous polymer film, this glass transition temperature will be lowered before the start of separation by swelling with a solvent to a level below or equal to the temperature of the at least one non-porous polymer film utilized as a separation medium.

3. A method according to claim 2, characterized in that the solvent contains at least one liquid from the group of protic, aprotic, aqueous, aliphatic, aromatic, heteroaliphatic, heteroaromatic, alicyclic, and/or heteroalicyclic liquids.

4. A method according to claim 1 characterized in that the at least one polymer film utilized for the separation consists of one or more of the following polymers and/or contains one or more of the following polymers selected from the group of polymers such as poly-(p-xylylene), polyvinylidene halides, polyester, polyether, polyolefins, polycarbonates, polyurethanes, natural polymers, polycarboxylic acids, polysulfonic acids, sulphated polysaccharides, polylactides, polyglycosides, polyamides, polyvinylalcohols, poly-α-methylstyrenes, polymethacrylates, polyacrylnitriles, poly-(p-xylyles), polyacrylamides, polyimides, polyphenylenes, polysilanes, polysiloxanes, polybenzimidazoles, polybenzthiazoles, polyoxazolines, polysulfinides, polyesteramides, polyarylenvinylenes, polyetherketones, polyurethanes, polysulfones, ormocerenes, polyacrylates, silicones, fully aromatic copolyesters, poly-N-vinylpyrrolidones, polyhydroxyethylmethacrylates, polymethylmethacrylates, polyethylenterephthalates, polymethacrylnitriles, polyvinylacetates, neoprene, Buna N, polybutadienes, polytetrafluorethylenes, modified or unmodified celluloses, α-olefins, vinylsulfonic acids, maleic acids, alginates or collagens.

5. A method according to claim 1 characterized in that the monomers that form the basis of the at least one polymer film can each support one or more functional groups, whereby each case is a singular type or different types of the substituents H, linear or branched alkyl, alkenyl, alkinyl, cycloalkyl, cycloalkenyl, cycloalkinyl, phenyl, phenylalkyl, phenylalkenyl, phenylalkinyl, phenylcycloalkyl, phenylcycloalkenyl, phenylcycloalkinyl, cycloalkyl-alkyl, cycloalkyl-alkenyl, cycloalkyl-alkinyl, heterocyclic compounds, heterocyclo-alkyl, heterocyclo-alkenyl, heterocyclo-alkinyl, linear or branched alkylsulphonate, alkenylsulphonate, alkinylsulphonate, linear or branched alkylbenzenesulphonate, alkenylbenzenesulphonate, alkinylbenzenesulphonate, aminosulphonyl-alkyl, aminosulphonyl-alkenyl, aminosulphonyl-alkinyl, aminosulphonyl-cycloalkyl, aminosulphonyl-cycloalkenyl, aminosulphonyl-cycloalkinyl, linear or branched alkyl-sulphonamide, alkenyl-sulphonamide, alkinyl-sulphonamide, cycloalkyl-sulphonamide, cycloalkenyl-sulphonamide, cycloalkinyl-sulphonamide, phenyl-sulphonamide, heterocyclo-sulphonic acid, heterocyclo-sulphonamide, heterocyclo-alkyl-sulphonic acid, heterocyclo-alkyl-sulphonamide, heterocyclo-alkenyl-sulphonic acid, amide- or esterlike bound linear and/or branched-chain aliphatic sulphonic, carbolyxic, and/or phosphonic acid, styrene sulphonic acid, anetol sulphonic acid, styrene phosphonic acid, heterocyclo-alkenyl-sulphonamide, heterocyclo-alkinyl-sulphonic acid, heterocyclo-alkinyl-sulphonamide, aryl-sulphonic acid, aryl-sulphonamide, aryl-alkyl-sulphonic acid, aryl-alkyl-sulphonamide, aryl-alkenyl-sulphonic acid, aryl-alkenyl-sulphonamide, aryl-alkinyl-sulphonic acid, aryl-alkinyl-sulphonamide, alkyl-, alkenyl, alkinyl-, aryl-, heteroalkyl-, heteroaryl-carboxylic acids, esters thereof, carboxylic acid amides thereof, amino acids, orthologous phosphonic acid derivatives of all sulphonic acids listed, hydroxy-alkyl-, hydroxy-alkenyl-, hydroxy-alkinyl-, hydroxy-cycloalkyl-, hydroxy-alkyl-cycloalkyl-, hydroxy-cycloalkyl-alkyl-, hydroxy-phenyl-, hydroxy-alkyl-phenyl-, hydroxy-phenyl-alkyl-groups as well as the orthologous amino- and thio-compounds, polyethoxy-alkyl, polyethoxy-alkenyl, polyethoxy-alkinyl, polyethoxy-cycloalkyl, polyethoxy-cycloalkenyl, polyethoxy-cycloalkinyl, polyethoxy-aryl, polyethoxy-alkyl-aryl, polyethoxy-heterocycloalkyl, polyethoxy-heterocycloaryl, alkanal, alkenal, alkinal, cycloalkenal, benzene carbaldehyde, heteroaryl-carbaldehyde, benzyl-alkyl-carbaldehyde, heteroaryl-carbaldehyde, aliphatic heteroalkyl-alkenal, hetero-alkenyl-alkenal, hetero-alkinyl-alkenal, alkanon, alkenon, alkinon, cycloalkyl-alkanon, dicycloalkanon, arylalkanon, heteroaryl-alkanon, imines, halogens und halogenated derivatives of all groups listed, nitriles, isonitriles, sulphonic acid esters, phosphonic acid esters, nitro compounds, hydroxylamines, allyl compounds, adenosin-3′,5′-monophosphate, adenosin-3′,5′-diphosphate, adenosin-3′,5′-triphosphate, guanosin-3′,5′-monophosphate, guanosin-3′,5′-diphophate, guanosin-3′,5′-triphosphate, dextransulphate cellulose, cation exchanging groups, anion exchanging groups, wherein alkyl preferably stands for a group with 1-20 carbon atoms, alkenyl and alkinyl preferably stand for mono- or polyunsaturated groups with 2-20 carbon atoms, cycloalkyl, -alkenyl and -alkinyl preferably stand for a group with 3-20 carbon atoms, the heterocyclic groups preferably stand for an R group with 1-20 carbon atoms, wherein up to 5 carbon atoms can be replaced by hetero atoms selected from the group nitrogen, oxygen, sulfur, phosphorus, aryl preferably stands for an aromatic R group with 5-20 carbon atoms, heteroaryl stands for a corresponding aromatic R group, wherein up to 5 carbon atoms are replaced by hetero atoms, which can be selected from the group nitrogen, oxygen, sulfur, phosphorus.

6. A method according to claim 1 characterized in that macromolecular components with a molecular weight between 50 g/mol and 500,000 g/mol, preferably between 1,000 g/mol and 50,000 g/mol, pass the permeation layer.

7. A method according to claim 1 characterized in that for separation, at least one polymer film with a thickness equal to or smaller than 100 micrometers, preferably a thickness equal to or smaller than 50 micrometers, with special preference for a thickness equal to or smaller than 1 micrometer, with very special preference for a thickness equal to or smaller than 100 nanometers.

8. A method according to claim 1 characterized in that at least one semi-crystalline polymer film is utilized for the separation.

9. A method according to claim 1 characterized in that chemically cross-linked polymer films are utilized for the separation.

10. A method according to claim 1 characterized in that for the separation, at least one polymer film is utilized which consists of block polymers, graft copolymers, or blends.

11. A method according to claim 1 characterized in that multi-layer films are utilized for the separation, wherein such polymer films are considered multi layer films which consist of at least two layers of differing or identical polymers.

12. A method according to claim 11 characterized in that a multi layer film is utilized in which the first polymer film is directly coated with the other polymer films.

13. A method according to claim 1 characterized in that for the separation, at least one polymer film is utilized which consists of several polymers with different chemical structures.

14. A method according to claim 1 characterized in that for the separation, at least one polymer film is utilized which features a chemical gradient.

15. A method according to claim 1 characterized in that for the separation at least one polymer film consisting of reactive polymers is utilized.

16. A method according to claim 1 characterized in that for the separation at least one polymer film is utilized which features a rough and/or porous surface topology.

17. A method according to claim 1 characterized in that for the separation at least one polymer film containing solid flux is utilized.

18. A method according to claim 1 characterized in that for the permeation, at least one polymer film that is coated on or between porous substrates is utilized.

19. A method according to claim 1 characterized in that for the separation at least one polymer film is utilized which features other geometries, preferably a polymer film consisting of hollow fibers.

20. A method according to claim 19 characterized in that the diameters of the hollow fibers' wall thicknesses are equal to or smaller than 5 micrometers, preferably equal to or smaller than 500 nanometers, with special preference for those that are equal to or smaller than 50 nanometers.

21. A method according to claim 1 characterized in that the polymer systems to be separated are presented dissolved in one single solvent or mixture of solvents.

22. A method according to claim 1 characterized in that the solution to be separated, which contains at least one macromolecule, has a portion of this one or more macromolecule/s of between 0.1 and 50 percent of its weight.

23. A method according to claim 1 characterized in that the separation is carried out in combination with light dispersion and/or viscosimetry and/or UV-Vis spectroscopy and/or gel permeation chromatography and/or solvent precipitation.

24. A method according to claim 1 characterized in that the pressure is adjusted in a controlled manner.

25. A method according to claim 1 characterized in that tandem configurations are utilized, whereby the term “tandem configurations” refers to such systems in which several permeation configurations, i.e. configurations with at least one non-porous polymer film each, are aligned parallel and/or one after the other, wherein between these permeation configurations there is a liquid medium.

26. Utilization of separation media containing at least one non-porous polymer film for the separation of one or more macromolecules from their mixtures with high or low molecular substances in respect to their molecular weights, their chemical structure, and/or their degree of branching.

27. Utilization of separation media containing at least one non-porous polymer film according to claim 26, characterized in that macromolecules with a molecular weight between 50 g/mol and 500,000 g/mol are separated.

28. Utilization of separation media containing at least one non-porous polymer film according to claim 26, characterized in that macromolecules with a molecular weight of more than 500,000 g/mol are purified.

29. Utilization of separation media containing at least one non-porous polymer film according to claim 26, characterized in that one or more macromolecules from byproducts in the synthesis of macromolecules and/or from catalysts and/or from colloidal additives are separated.
